(19) United States
(12) Patent Application Publication
(10) Pub. No.: US 2021/0049469 A1
(43) Pub. Date: Feb. 18, 2021

(54) MEMORY REMAPPING FOR SPARSE NEURAL NETWORKS

(71) Applicant: NEC Laboratories Europe GmbH, Heidelberg (DE)

(72) Inventors: Nicolas Weber, Dossenheim (DE); Felipe Huici, Heidelberg (DE)

(21) Appl. No.: 16/542,332

(22) Filed: Aug. 16, 2019

(51) Int. Cl. G06N 3/08; G06N 3/04; G06N 20/00

(52) U.S. Cl. CPC G06N 3/082; G06N 20/00; G06N 3/0454

(57) ABSTRACT

A method of memory remapping for utilizing dense neural network computations with a sparse neural network includes the step of densifying the sparse neural network. The input and output data is remapped onto the densified neural network. The dense neural network computations are utilized for a prediction using the remapped input and output data.

### FIELD

The present invention relates to artificial intelligence (AI), and in particular to neural networks and methods and systems for memory remapping in order to reduce the memory requirements and computation effort required by dense neural networks and/or provide for the use of dense neural network operations for sparse neural networks.

### BACKGROUND

Currently, AI computations for neural networks such as a multilayer perceptron (MLP), convolutional neural network (CNN), etc. are performed by dense operations because such operations map rather well onto single instruction, multiple data (SIMD) deployments and vector architectures like those of general-purpose computing on graphics processing units (GPGPUs) and the AURORA vector engine processor by the company NEC CORP.

Bell, N., et al., “Efficient Sparse Matrix-Vector Multiplication on CUDA,” NVIDIA Technical Report, NVR-2008-004 (December 2008), which is hereby incorporated by reference herein in its entirety, describe that sparse matrix structures arise in in different applications and provide an overview of sparse matrix formats. Sparse matrix computations such as sparse matrix-vector multiplication can be performed on the sparse matrix structures.

### SUMMARY

In an embodiment, the present invention provides a method of memory remapping for utilizing dense neural network computations with a sparse neural network. The method includes the step of densifying the sparse neural network. The input and output data is remapped onto the densified neural network. The dense neural network computations are utilized for a prediction using the remapped input and output data.

### BRIEF DESCRIPTION OF THE DRAWINGS

The present invention will be described in even greater detail below based on the exemplary figures. The invention is not limited to the exemplary embodiments. All features described and/or illustrated herein can be used alone or combined in different combinations in embodiments of the invention. The features and advantages of various embodiments of the present invention will become apparent by reading the following detailed description with reference to the attached drawings which illustrate the following:

FIG. 1 schematically illustrates a dense neural network;

FIG. 2 schematically illustrates a first step of sparsification by removal of edges;

FIG. 3 schematically illustrates a first iterative step of removing disconnected edges;

FIG. 4 schematically illustrates a sparse neural network formed in accordance with an embodiment of the present invention by removing computations from the dense neural network of FIG. 1 which do not contribute to the output; and

FIG. 5 schematically illustrates the sparse neural network of FIG. 2 which has been remapped in accordance with an embodiment of the present invention.

### DETAILED DESCRIPTION

The inventors have recognized that, with increasing model size and input data, dense neural network formats can exceed available device memory, especially in edge deployments. The inventors have also recognized that sparse neural network computation methods, including those which are intended to be used on SIMD and vector hardware, due to their sparsity, are much less efficient than dense neural network computations and require a relatively large amount of gather-scatter operations at runtime, resulting in a significant performance drop. Also, sparse neural network computations do not map as effectively to SIMD deployments and vector architectures as dense neural network computations do. Further, in contrast to parameter pruning methods, which try to erase parts of the parameters to reduce memory consumption, embodiments of the present invention provide for the ability to densify a sparse neural network and for more efficient dense neural network computations.

Embodiments of the present invention provide a method, system and computer-readable medium for sparsification of a neural network through memory remapping using an ahead-of-time boundary condition checking to identify neurons with synapses (which can also be referred to as edges) that do not contribute to the final output. These identified neural network connections can then be removed. The sparsification can be applied to dense neural networks, or neural networks that are already sparse, and in either case provides a sparse neural network as output.

Embodiments of the present invention provide a method, system and computer-readable medium for densification of a sparse neural network, preferably the sparse neural network which is output from the sparsification, through memory remapping of the values into dense memory formats. This advantageously allows for the use of more computationally-efficient dense arithmetic methods on the resulting densified neural network than could be performed with a typical sparse neural network, thereby saving memory and computational resources.

The current state of the art of AI computations and neural network processing heavily relies on dense matrix-matrix multiplications (e.g., for dense or convolution layers) or other dense arithmetic (e.g., for element-wise or pooling layers). However, such dense neural network computations do not work with sparse matrix formats and require a re-write of all compute kernels for all of the different sparse matrix formats. Even worse, depending on the structure of the data, different sparse memory formats could potentially work optimally, but would require analysis and conversion to an optimal layout. Further, due to their sparsity, sparse computations are always much less efficient than dense computations and require a lot of gather-scatter operations at runtime, resulting in a significant performance drop.

Dense memory formats typically work as arrays (e.g., data[Y][X] with X and Y specified for each element) such that it is possible to access an element with just a single operation (e.g., to access the element data[5][23], one can use data+X*5+23). In contrast, sparse memory formats work differently (e.g., X[NUM]; Y[NUM]; data[NUM]) and do not allow to directly access a specific element. Instead, indirections are used for sparse neural networks (e.g., loop: for(i in range(0,NUM)): if (Y[i]==5 and X[i]==23): return data[i].

Embodiments of the present invention introduce a memory remapping for sparse neural network predictions. According to embodiments of the present invention, it is first analyzed and determined which synapses and neurons of a trained neural network have zero contribution to the output or final result. These synapses and neurons, and any other ones stemming from them, are then removed in accordance with embodiments of the present invention.

In an embodiment, a method of memory remapping for utilizing dense neural network computations with a sparse neural network is provided, the method comprising:
densifying the sparse neural network;
remapping input and output data onto the densified neural network; and
utilizing the dense neural network computations for a prediction using the remapped input and output data.

In the same or other embodiment, the sparse neural network is formed from a dense neural network by identifying and removing edges of the dense neural network having a zero value range which do not contribute to a final result.

In the same or other embodiment, the identifying of the edges of the dense neural network having the zero value range includes locating multiplication operations with a zero weight in layers of the dense neural network.

In the same or other embodiment, the identifying of the edges of the dense neural network having the zero value range further includes locating negative bias values in layers of the dense neural network in which a maximum input value is smaller than the bias values and which are followed by a rectifier linear unit (ReLU).

In the same or other embodiment, the identifying of the edges of the dense neural network having the zero value range further includes locating negative weight values in layers which are followed by a ReLU.

In the same or other embodiment, the sparse neural network is further formed by removing edges which have a value range which is less than a predetermined threshold.

In the same or other embodiment, the method further comprises determining whether value ranges in a threshold layer are always less than or always greater than a predetermined threshold, removing computations prior to the threshold layer, and using either a first value or a second value for computations following the threshold layer depending on the determination of whether the value ranges in the threshold layer are always less than or always greater than the predetermined threshold.

In the same or other embodiment, the method further comprises generating code for instructing a processor or hardware layout to utilize the dense neural network computations based on the densified neural network.

In the same or other embodiment, the sparse network is formed from an initial sparse or dense neural network using an iterative process of identifying and removing disconnected edges of the initial sparse or dense neural network which do not contribute to a final result.

In the same or other embodiment, the iterative process goes from an output layer toward in input layer.

In another embodiment, a system for memory remapping to transform a sparse neural network into a dense neural network is provided, the system comprising memory and one or more processors which, alone or in combination, are configured to provide for execution of a method comprising:
densifying the sparse neural network;
remapping input and output data onto the densified neural network; and
utilizing dense neural network computations for a prediction using the remapped input and output data.

In the same or other embodiment, the system is further configured to form the sparse neural network from a dense neural network by identifying and removing edges of the dense neural network having a zero value range which do not contribute to a final result.

In the same or other embodiment, the system is further configured to form the sparse network from an initial sparse or dense neural network using an iterative process of identifying and removing disconnected edges of the initial sparse or dense neural network which do not contribute to a final result.

In the same or other embodiment, the system is further configured to generate code for instructing a processor or hardware layout to utilize the dense neural network computations based on the densified neural network.

In a further embodiment, a tangible, non-transitory computer-readable medium having instructions thereon is provided, which, upon being executed by memory and one or more processors, provide for execution of a method comprising:
densifying the sparse neural network;
remapping input and output data onto the densified neural network; and
utilizing dense neural network computations for a prediction using the remapped input and output data

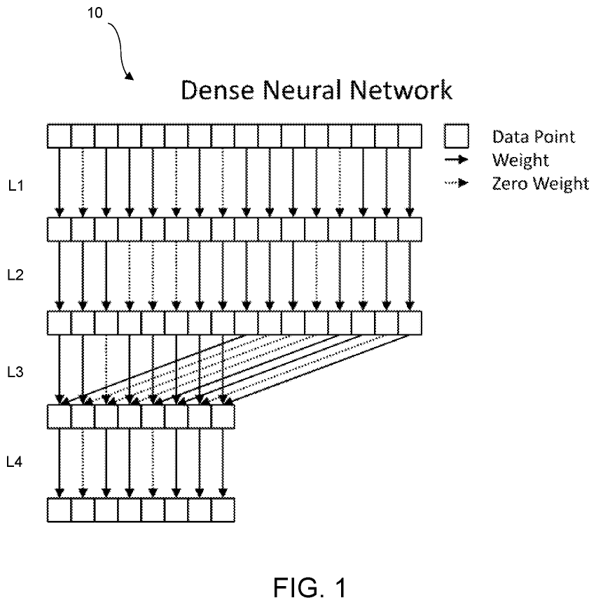

FIG. 1 schematically illustrates an example of a dense neural network 10 with four layers L1-L4. L1is the input layer, L4 is the output layer and layers L2 and L3 are hidden layers. Layers L1, L2 and L4 operate element-wise and layer L3 performs a convolution operation. In other embodiments different formats and number of hidden layers, as well as the operations they perform, can be varied. The data points represent the neurons of the dense neural network 10 which are connected by edges as indicated by the arrows in a direction of a computation stream from the input layer L1 to the output layer L4. Some of the neurons and synapses have a zero weight (as indicated by the dashed arrows), or in other words have a zero input value range and/or otherwise do not or so not significantly contribute to the output or final result as determined in accordance with embodiments of the present invention. These edges can be removed.

In order to quickly and efficiently identify the neurons and synapses of the dense neural network 10 which do not or do not significantly contribute to the output or final result, embodiments of the present invention perform ahead-of-time boundary checks. First, the input value range (e.g., [0, 1]) is determined, then the entire dense neural network is parsed and the value range for each neuron after each layer is updated depending on the operations performed by the individual neurons. For example, the boundaries can be checked for the following example operations to yield the value range of a respective neuron in a respective computation stream:
Weights: B(X)=B(X-1)*W=[0, W]
Additions: B(X)=B(X-1)+A=[A, 1 +A]
Min: B(X)=min(B(X-1), 0.5)=[0, 0.5]
Max: B(X)=max(B(X-1), 0.5)=[0.5,1]
Sigmoid Function, Sin, Cos, and other functions which results in a limited range value.
   where B(X) is the boundary of a neuron to be determined, B(X-1) is the boundary of a preceding neuron in the computation stream, W is the weight in a weighted multiplication operation and A is the value of an addition in an addition operation. In the Min example, 0.5 is used, however, other values could be used.

After all the value ranges have been calculated, all zero value ranges [0, 0] can then be identified. Examples of operations which result in zero value ranges include:
Multiplication with zero weights in layers (W=0):

[Imin, Imax]*0 =[0,0]
Negative bias values in layers, when the input max value is smaller than the bias B, and followed by a rectifier linear unit (ReLU):

max([Imin+B, Imax+B], 0)=[0, 0], with Imax<=−B and B<0.
Negative weight values in layers, when followed by a ReLU.

max([Imin*W, Imax*W], 0)=[0, 0], with Imax>=0 and W<0.

Embodiments of the present invention can additionally identify value ranges that do not significantly contribute to the output or final result. In this case, the calculated value ranges can each be compared to a threshold, and the synapses and neurons in a computation stream containing the value range which will not significantly contribute to the output or final result are removed. For example: given these four calculated value ranges: [−0.00001, 0.0001], [0, 0.0000001], [0, 5], [2, 234949], the first two could be safely removed without influencing the result significantly because they are relatively much smaller than the other two ranges. The threshold can be predetermined (e.g., 0.0001) or set, for example, based on the smallest, average, median and/or largest value ranges (e.g., as a percentage of any of these values).

According to an embodiment of the present invention, computation streams can be simplified to save computational power and do not need to be removed entirely. In a threshold layer (if(I<=T) O=X, else O=V) it can be that the input value range is always smaller than T, so that X can always be used, or if always bigger than T, then V can always be used. The output is designated by O, while X is the input and V is a predefined value which gets set if the threshold condition is not satisfied. This allows to remove all preceding computations, and then continue from this point on with X or V. This applies to all layers with min/max operations (e.g. ReLU, ReLU6, Threshold, HardTanh, etc.). For example, a ReLU can be expressed as a threshold layer with if(I≥0), then O=I, else O=0, wherein O is the output. Thus, if a value is below or above a given threshold in the threshold layer, it passes through with this value, otherwise it gets replaced with a predefined value.

Accordingly, embodiments of the present invention provide a method, system and computer-readable medium for removing all edges that will not or will not significantly contribute to the output or final result, either because the weights are zero, and/or the boundary checks determine that the value ranges of variables will always resolve to non-contributing values, e.g. negative value ranges in a ReLU layer, and/or the boundary checks result in value ranges below a threshold. This results in more effective removal of edges which actually will not or will not significantly contribute to the output, and thereby more accurate predictions, in comparison to the removal of entire feature maps from the parameters in parameter pruning methods. For example, given a parameter filter as weights [3] [2] [2], after pruning it become weights[1][2][2], which means that eight out of twelve parameters have been removed. The following example illustrates one problem with pruning.

[1.0][0.0] [0.0][0.5] [5.0][8.0]

[0.0][0.0] [0.5][0.0] [1.0][7.0]

In this example, the pruning would remove the first eight weights, but since the first eight weights are not all zero, the pruning would remove connections that actually contribute to the output.

Exemplary pseudocode for the sparsification according to an embodiment of the invention could be as follows:

def sparsify(node, range)
node. setRange(range)
range=node.updateOutputRange(range)
for leaf in node.leavesO:
sparsify(node, range)

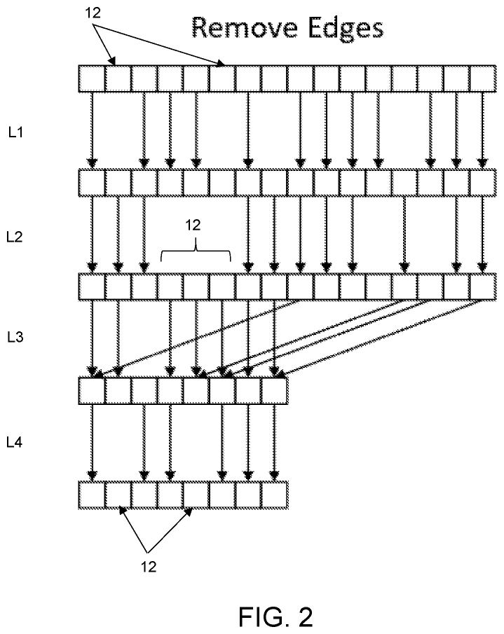

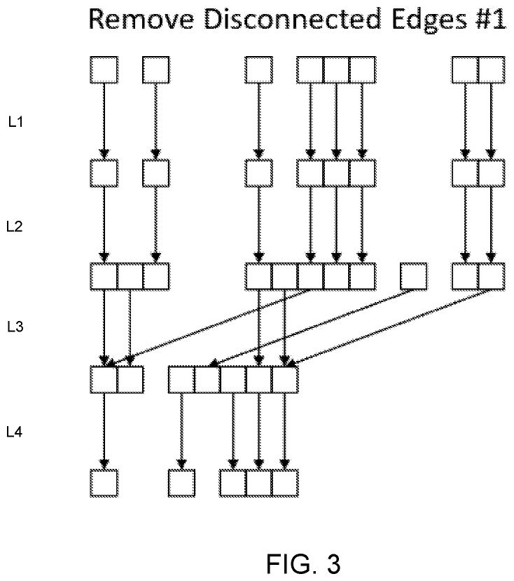

FIG. 2 illustrates a first step of the sparsification in which edges of the computation graph which do not contribute to the output of layer L4 have been removed (see edges in the dense neural network 10 of FIG. 1 having the zero weights as indicated by the dashed lines). This results in a number of neurons 12 with disconnected edges which are removed in a first iteration illustrated in FIG. 3. Preferably starting from the output layer L4 and going toward the input layer L1, preferably layer by layer, disconnected edges are removed until only the neurons in computation streams which run from the input layer L1 to the output layer L4 remain. In this manner, removal of neurons in layers closer to the output layer L4 provides to also remove the computation streams preceding those layers, thereby also identifying neurons in the input layer L1 and layers closer to the input layer L1 which do not contribute to the final result, and removing those neurons. Advantageously, this significantly reduces the amount of computations and thereby speeds up processing and saves computations resources. In other words, if a connection in the layer L4 is removed, the calculations preceding it can be advantageously removed as well since the result of them would not be used. It is further possible working the other direction that if a connection in layer L1 is removed, the effect is propagated through the subsequent layers L2-L4.

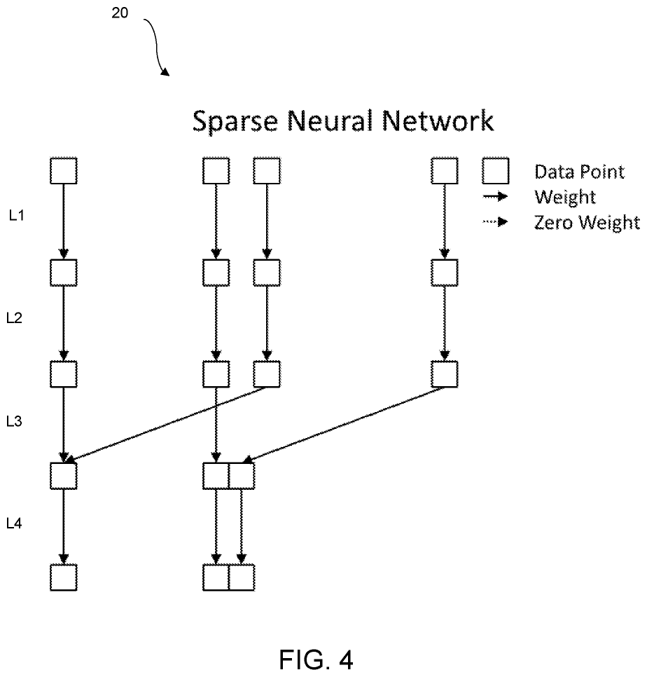

At the end of the iterative process of removing disconnected edges, a sparse neural network 20 shown in FIG. 4 is produced from the dense neural network 10 of FIG. 1 by the iterative process removing the computation streams containing neurons with disconnected edges which have been determined to not or not significantly contribute to the output or final result. The memory locations of neurons to be removed, and neurons that remain are known, for example, from the row/column information in the dense neural network 10. Generally, the structure and parameters of the neural networks are known at the outset prior to adapting them according to embodiments of the present invention, and the actual input and output data is later mapped onto the adapted neural networks.

The sparse neural network 20, or another already sparse neural network, can then undergo densification through memory remapping according to embodiments of the present invention to advantageously provide for the use of more efficient operations designed to operate with dense neural network memory formats. Exemplary pseudocode for densification by memory remapping according to an embodiment of the present invention could be as follows:

def sparsify(node, range)

node.setRange(range)
range = node.updateOutputRange(range)
for leaf in node.leaves( ):

sparsify(node, range)

def densify(node):

if(node.allLeavesHaveBeenProcessed( )):

node.remapEdges( )
reverse_sparsify(node.parent( ))

network = User.initNetwork( )
sparsify(network.begin( ), [0, 1])
for(node : network.nodes( )):

node.removeUnncessaryEdgesDependingOnRange( )

hasChanged = True
while(hasChanged):

hasChanged = False
for(node : network.nodes( )):

hasChanged |= node.removeDisconnectedEdges( )

network.remap( )

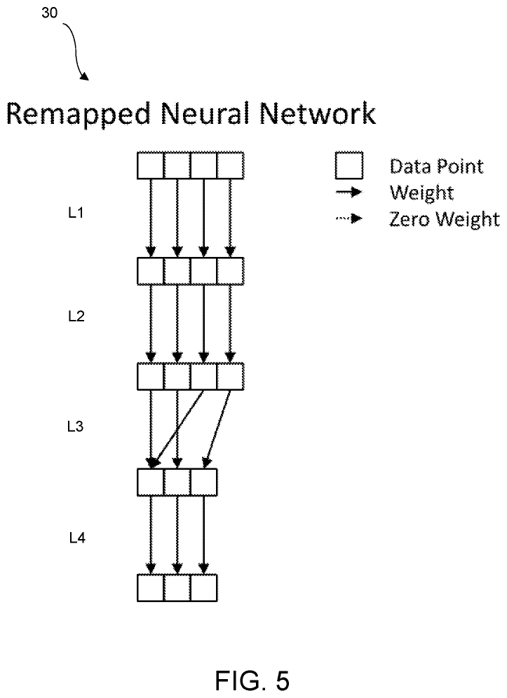

FIG. 5 shows the remapped neural network 30 after densification of the sparse neural network 20, which is able to use dense arithmetic to compute only the remaining connections. To be usable, the input and output data is mapped onto the densified data layout.

The following is an example of remapping a sparse neural network to be densified:

struct Sparse {

```
  int x[ ] = {2, 3, 3, 5, 5};
  int y[ ] = {1, 1, 2, 3, 6};
  float v[ ] = {...};
}
which is:
```

I[1][2], I[1][3], I[2][3], I[3][5], I[6][5]

and this is remapped to:

I[0][0], I[0][1], I[1][1], I[2][2], I[3][2]

In other words, as a more visual representation, the sparse data is as follows:

X 0 1 2 3 4 5
/-----------
0|0 0 0 0 0 0
1|0 0 1 2 0 0
2|0 0 0 3 0 0
3|0 0 0 0 0 4
4|0 0 0 0 0 0
5|0 0 0 0 0 0
6|0 0 0 0 0 5

and the densified data is as follows:

χ 0 1 2
/-----
0|1 2 0
1|0 3 0
2|0 0 4
3|0 0 5

According to another example, it is possible to remove all zeros, so that a linear array[1, 2, 3, 4, 5] is obtained.

For the foregoing examples, the following exemplary computations with the respective memory formats demonstrates the computational improvements provided by densification:

# Sparse: worst case: 36 * (2 * N) iterations, best case: 36 iterations

```
int oi = 0;
for(int y = 0; y < 6; y++):
  for(int x = 0; x < 6; x++):
  // Find Input value
  int ii = 0;
  for(; ii < N && I.x[ii] < x && I.y[ii] < y; ii++);
  // Find Weight value
  int wi = 0;
  for(; wi < N && W.x[wi] < x && W.y[wi] < y; wi++);
  // I and W found?
  if(ii < N && wi < N && I.x[ii] == x && I.y[ii] && W.x[wi] == x && W.y[wi] ==
y):
```

// Create a new Item in O and calculate the result
O.x[oi] = x;
O.y[oi] = y;
O.v[oi] = I.v[ii] * W[y][x];
oi++;

# Dense: 36 iterations

```
for(int y = 0; y < 6; y++):
  for(int x = 0; x < 6; x++):
  Output[y][x] = Input[y][x] * Weight[y][x];
```

# Simple densified: 12 iterations (from the visual representation example)

```
for(int y = 0; y < 4; y++):
  for(int x = 0; x < 3; x++):
  Output[y][x] = Input[y][x] * weight[y][x];
```

# Maximal densified: 6 iterations (from the linear array example)

for(int i = 0; i < 6; i++):
Output[i] = Input[i] * Weight[i];

Thus, embodiments of the present invention provide for identification of neurons with value ranges that are zero or not significantly contributing, and for removal their computations from the computation graph, followed by remapping the input/output data of layers and the network. An embodiment of a method according to the present invention includes the following steps:
Automatically identify the zero value ranges that do not contribute and/or do not contribute significantly to the output or final result.
Remove all edges of the computation graph that do not contribute to the final result to provide a sparse data layout.
Densify the sparse data layout.
Remap the input and output data onto the densified data layout.
Automatically generate code (e.g., for a central processing unit (CPU), graphical processing unit (GPU) or NEC AURORA) or hardware layouts (e.g., field-programmable gate array (FPGA)) to use dense instead of sparse computations.

Static library approaches are very limited and assume data to be represented in specified layouts, etc. A code generator can therefore generate code that is much more fine-tuned to the final remapped neural network 30. For example, referring to FIG. 3, a library-based implementation for layer L3 would always assume that every outgoing connection has two inputs, which is not the case in this example. The code generation being based on the final remapped neural network 30 therefore provides to configure the computations to be dense neural network computations which fit to what is occurring in the final remapped neural network 30.

Embodiments of the present invention therefore provide a number of improvements to the computer systems and hardware running predictions using the neural network. These improvements include less memory consumption by removing unnecessary connections or computation streams from the network since the zeros are then not stored either in the network weights nor the input and output data. Also, for networks too large to be stored in a dense format, embodiments of the present invention advantageously provide to still be able to use dense memory formats that do not require to additionally store the column/row information such as the case with sparse memory formats. For example, a sparse memory format works as follows: Struct Format {int x[N]; int y[N]; float value N}, such that to access an element from the dense memory format (e.g., I[5][3]), the following can be performed:

float lookup(Format& I, int y, int x) {
int i = 0;
for(; i < N && I.x[i] < x && I.y[i] < y; i++);
if(I.x[i] == x && I.y[i] == y)
return I.value[i];
else
return 0.0f; // NOT FOUND!
}

Moreover, the improvements include faster computation and computational resource savings by providing for higher performance. Sparse memory formats use indirections which require much less computational and memory access overhead compared to dense formats. For example, a lookup function for a dense memory format could be as follows:

float lookup(Dense& I, int y, int x) {
return I[y][x];
}

Further, the unnecessary computation of weights are avoided according to embodiments of the present invention along with other computations which do not or do not significantly contribute to the final result, thereby speeding up the overall computation.

By using the inventive value range analysis, the removal of edges from the computation graph according to embodiments of the present invention is much more sophisticated, being based on much more detailed information, thereby resulting in increased accuracy compared to pruning, for example. Embodiments of the present invention permit to propagate sequentially through the layers from back to front in the neural network (see reverse-sparsify part of the exemplary pseudocode above) which connections contribute significantly to the output. By removing edges at the end of computational streams, calculations of previous results can be omitted. For example, starting from the bottom in FIG. 1, the second element which is marked as “Zero Weight” will not contribute to the result, so it is removed, as well as all preceding computations in the computation stream to this element.

Moreover, the value range analysis also allows to eliminate more connections than other approaches, such as parameter pruning methods. For example, the range [0, +inf] being determined to be multiplied with a negative number would become [−inf, −0], and followed by a ReLU would become [0, 0], which can be eliminated in accordance with embodiments of the present invention. For example, the ReLU is implemented as y=max(x,0) and therefore removes all negative values. If a value is determined to be in the range [−inf, −0], it can be removed in accordance with embodiments of the present invention since it will never be a positive value. This can happen, for example, when there is a negative weight multiplied ahead of the ReLU.

Embodiments of the present invention are particularly advantageous to be used with large neural networks or neural networks with a significant amount of computations that yield zero value ranges, or insignificant value boundaries. Transparent acceleration of large sparse neural networks can advantageously be provided for on any kind of hardware (SIMD, VECTOR or FPGA) by using the more efficient dense neural network computations.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

What is claimed is:

1. A method of memory remapping for utilizing dense neural network computations with a sparse neural network, the method comprising:
densifying the sparse neural network;
remapping input and output data onto the densified neural network; and
utilizing the dense neural network computations for a prediction using the remapped input and output data.

2. The method according to claim 1, wherein the sparse neural network is formed from a dense neural network by identifying and removing edges of the dense neural network having a zero value range which do not contribute to a final result.

3. The method according to claim 2, wherein the identifying of the edges of the dense neural network having the zero value range includes locating multiplication operations with a zero weight in layers of the dense neural network.

4. The method according to claim 3, wherein the identifying of the edges of the dense neural network having the zero value range further includes locating negative bias values in layers of the dense neural network in which a maximum input value is smaller than the bias values and which are followed by a rectifier linear unit (ReLU).

5. The method according to claim 3, wherein the identifying of the edges of the dense neural network having the zero value range further includes locating negative weight values in layers which are followed by a rectifier linear unit (ReLU).

6. The method according to claim 2, wherein the sparse neural network is further formed by removing edges which have a value range which is less than a predetermined threshold.

7. The method according to claim 2, further comprising determining whether value ranges in a threshold layer are always less than or always greater than a predetermined threshold, removing computations prior to the threshold layer, and using either a first value or a second value for computations following the threshold layer depending on the determination of whether the value ranges in the threshold layer are always less than or always greater than the predetermined threshold.

8. The method according to claim 1, further comprising generating code for instructing a processor or hardware layout to utilize the dense neural network computations based on the densified neural network.

9. The method according to claim 1, wherein the sparse network is formed from an initial sparse or dense neural network using an iterative process of identifying and removing disconnected edges of the initial sparse or dense neural network which do not contribute to a final result.

10. The method according to claim 9, wherein the iterative process goes from an output layer toward in input layer.

11. A system for memory remapping to transform a sparse neural network into a dense neural network, the system comprising memory and one or more processors which, alone or in combination, are configured to provide for execution of a method comprising:
densifying the sparse neural network;
remapping input and output data onto the densified neural network; and
utilizing dense neural network computations for a prediction using the remapped input and output data.

12. The system according to claim 11, being further configured to form the sparse neural network from a dense neural network by identifying and removing edges of the dense neural network having a zero value range which do not contribute to a final result.

13. The system according to claim 11, being further configured to form the sparse network from an initial sparse or dense neural network using an iterative process of identifying and removing disconnected edges of the initial sparse or dense neural network which do not contribute to a final result.

14. The system according to claim 11, being further configured to generate code for instructing a processor or hardware layout to utilize the dense neural network computations based on the densified neural network.

15. A tangible, non-transitory computer-readable medium having instructions thereon, which, upon being executed by memory and one or more processors, provide for execution of a method comprising:
densifying the sparse neural network;
remapping input and output data onto the densified neural network; and
utilizing dense neural network computations for a prediction using the remapped input and output data.
